(19) United States
(12) Patent Application Publication
(10) Pub. No.: US 2026/0164133 A1
(43) Pub. Date: Jun. 11, 2026

(54) CONTROL APPARATUS, OPTICAL APPARATUS, CONTROL METHOD, AND STORAGE MEDIUM

(71) Applicant: CANON KABUSHIKI KAISHA, Tokyo (JP)

(72) Inventors: TAMAKI NEGISHI, Tokyo (JP); SHIMPEI ITAGAKI, Tokyo (JP); NAOKI NOMURA, Kanagawa (JP); TORU MATSUMOTO, Kanagawa (JP); MAI NAKABAYASHI, Kanagawa (JP)

(21) Appl. No.: 19/395,488

(22) Filed: Nov. 20, 2025

(30) Foreign Application Priority Data
Dec. 10, 2024 (JP) 2024-215125
Nov. 5, 2025 (JP) 2025-186322

(51) Int. Cl. H04N 23/68

(52) U.S. Cl. CPC H04N 23/687; H04N 23/6812

(57) ABSTRACT

A control apparatus includes one or more memories storing instructions, and one or more processors that, upon execution of the instructions, operate to control a plurality of drive units, each of which moves a movable element, which is either an optical element included in an imaging optical system or an image sensor configured to receive a light beam from the imaging optical system, in a direction different from an optical axis direction of the imaging optical system, and select, by using information on a drive characteristic of each of the plurality of drive units, a periodic drive unit for periodically moving the movable element among the plurality of drive units.

### BACKGROUND

### Field of the Technology

The aspect of the disclosure relates to one or more embodiments of a control apparatus, an optical apparatus, a control method, and a storage medium.

### Description of the Related Art

One of the conventional methods obtains a low-pass filter (LPF) effect without using an LPF during imaging by driving a movable element (such as an image sensor or a lens), which is shiftable in a plane orthogonal to an optical axis, at a high frequency with a minute amplitude. Hereinafter, this method will be referred to as LPF drive of the movable element.

Japanese Patent Application Laid-Open No. 2022-011043 discloses an image pickup apparatus capable of sensor image stabilization (also referred to as sensor IS) by shifting an image sensor, lens image stabilization (also referred to as lens IS) by shifting a lens, and LPF drive using these movable elements.

### SUMMARY

A control apparatus according to one aspect of the disclosure may include one or more memories storing instructions, and one or more processors that, upon execution of the instructions, operate to control a plurality of drive units, each of which moves a movable element, which is either an optical element included in an imaging optical system or an image sensor configured to receive a light beam from the imaging optical system, in a direction different from an optical axis direction of the imaging optical system, and select, by using information on a drive characteristic of each of the plurality of drive units, a periodic drive unit for periodically moving the movable element among the plurality of drive units. A control apparatus according to another aspect of the disclosure may include one or more memories storing instructions, and one or more processors that, upon execution of the instructions, operate to control driving of a first drive unit configured to move an optical element included in an imaging optical system in a direction different from an optical axis direction of the imaging optical system, and a second drive unit configured to move an image sensor configured to receive a light beam from the imaging optical system, in a direction different from the optical axis direction of the imaging optical system, and select, by using information on shake, from among the first drive unit and the second drive unit, a periodic drive unit configured to move the optical element or the image sensor with a period different from a period of image stabilization during an exposure time. An optical apparatus having each of the above control apparatuses, a control method corresponding to each of the above control apparatuses, and a storage medium storing a program that causes a computer to execute the above control method also constitute another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are block diagrams illustrating the configuration of an image pickup apparatus according to a first embodiment.

FIG. 2 is a schematic diagram illustrating LPF drive of a sensor IS unit in the first embodiment.

FIGS. 3A and 3B are schematic diagrams illustrating other LPF drive of a sensor IS unit in the first embodiment.

FIG. 4 is a flowchart illustrating processing according to the first embodiment.

FIGS. 5A and 5B illustrate drive characteristics of a sensor IS unit and a lens IS unit in the first embodiment.

FIG. 6 is a schematic diagram illustrating an image stabilizing unit (also referred to as IS unit) according to a second embodiment.

FIG. 7 is a flowchart illustrating imaging processing according to the second embodiment.

FIG. 8 is a flowchart illustrating imaging processing according to a third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Hereinafter, each embodiment of the disclosure will be described with reference to the drawings.

### First Embodiment

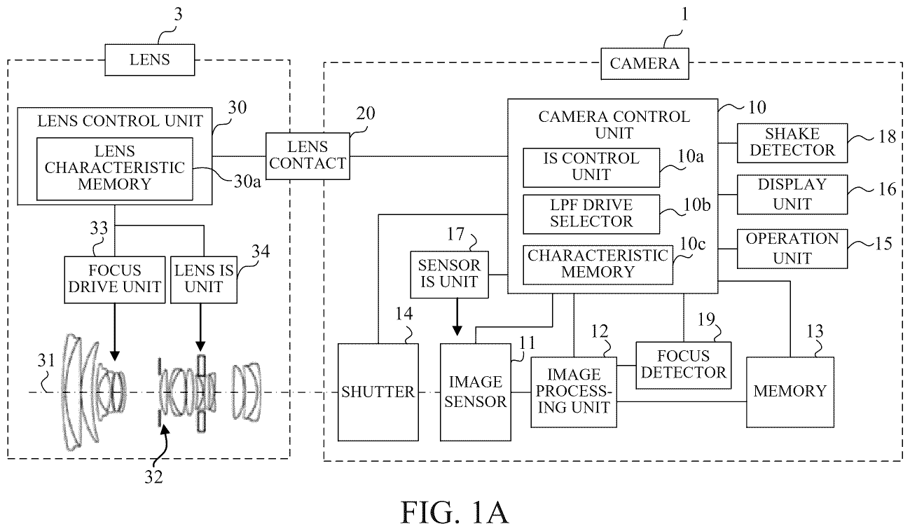

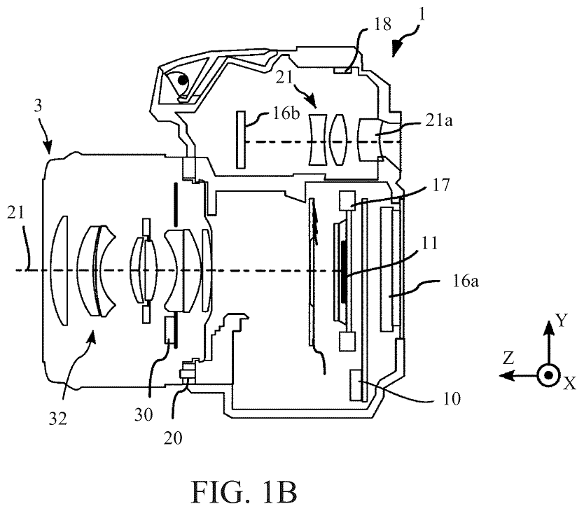

FIGS. 1A and 1B illustrate the configuration of a digital camera (simply referred to as a camera hereinafter) 1, which is an image pickup apparatus (optical apparatus) according to this embodiment. An interchangeable lens 3, which serves as a lens apparatus, is attachable to and detachable from the camera 1 according to this embodiment.

The camera 1 includes an image sensor 11 which receives a light beam from an imaging optical system 32 in the interchangeable lens 3 and photoelectrically converts (images) an object image formed by the light beam, an image processing unit 12 which generates an image from an imaging signal output from the image sensor 11, and a memory 13 which records information such as images.

The image sensor 11 can generate one or more images according to an operation of an unillustrated imaging instruction switch (release switch) of the camera 1. The image processing unit 12 generates an image by performing white balance processing, gamma correction, interpolation processing, and the like on the imaging signal.

The camera 1 further includes a shutter 14 such as a focal-plane shutter, which controls an exposure amount of the image sensor 11, an operation unit 15 configured to receive an operation by a user, a display unit 16 configured to display information such as images, and a (view)finder optical system 21 through which the user observes a finder image. The operation unit 15 includes a power switch, a release switch, and a dial for setting a variety of operations.

The display unit 16 includes, as illustrated in FIG. 1B, a rear liquid crystal unit 16a provided on a rear surface of the camera 1 for displaying a live-view image and the like, and a finder display unit 16b for displaying a live-view image and the like so as to be viewable through an eyepiece lens 21a of the finder optical system 21.

The camera 1 further includes a sensor IS unit 17, a shake detector 18, and a camera control unit 10. The sensor IS unit 17 is a sensor drive unit which drives the image sensor 11, which serves as a movable element, in a plane orthogonal to an optical axis 31 of the imaging optical system 32 (a direction different from the optical axis direction). The shake detector 18 detects shake of the camera 1 due to hand shake or the like (referred to as camera shake hereinafter) and outputs a shake signal. The camera control unit 10 includes a CPU or the like (one or more processors) and performs the overall control of the camera 1. The camera control unit 10 includes one or more memories (not illustrated) storing instructions, such as a RAM and a ROM.

The camera control unit 10 includes an IS control unit 10a, an LPF drive selector (selection unit) 10b, and a characteristic memory 10c. The one or more processors of the camera control unit 10 that, upon execution of the instructions stored in the one or more memories, operate to serve as the IS control unit 10a and the LPF drive selector 10b. The one or more memories may include the characteristic memory 10c. The IS control unit 10a calculates a sensor IS amount for the sensor IS unit 17 and a lens IS amount for a lens IS unit 34, which will be described later, based on the shake signal from the shake detector 18, and controls their driving, or controls LPF drive of the sensor IS unit 17 or the lens IS unit 34. Details of the LPF drive will be described later. The characteristic memory 10c stores information on drive characteristics of the sensor IS unit 17 (referred to as sensor drive characteristic information hereinafter) and lens drive characteristic information, which will be described later, on the interchangeable lenses 3 that have been attached to the camera 1 in the past. The sensor drive characteristic information may be information that directly indicates the drive characteristics themselves of the sensor IS unit 17, or information convertible into the drive characteristics.

The LPF drive selector 10b compares the drive characteristics of the sensor IS unit 17 indicated by the sensor drive characteristic information acquired from the characteristic memory 10c, with drive characteristics of the lens IS unit 34 indicated by the lens drive characteristic information, which will be described later, acquired from the characteristic memory 10c or from the interchangeable lens 3 (outside the memory). Then, in accordance with the comparison result, the LPF drive selector 10b selects one of the image stabilizing units, which is either the sensor IS unit 17 (second drive unit) or the lens IS unit 34 (first drive unit), as an image stabilizing unit which performs the LPF drive (periodic drive unit; referred to as LPF image stabilizing unit hereinafter).

A control apparatus (camera control unit 10) includes the IS control unit 10a, the LPF drive selector 10b, and the characteristic memory 10c. The control apparatus may be provided in the interchangeable lens (optical apparatus) 3, or may include an external personal computer located outside the camera 1. The shake detector 18 may be provided in the interchangeable lens 3, or may be provided in both the camera 1 and the interchangeable lens 3. In this case, the IS control unit 10a may receive a shake signal from the shake detector 18 provided in the interchangeable lens 3 and use the shake signal to calculate the sensor IS amount and the lens IS amount.

The camera control unit 10 also detects the luminance of an object using an imaging signal from the image sensor 11 or from an image generated by the image processing unit 12, and calculates a shutter speed and an aperture value in accordance with the luminance.

The camera 1 includes a focus detector 19. Each pixel included in the image sensor 11 in this embodiment includes a microlens and a plurality of photoelectric converters. The focus detector 19 detects, as focus detection processing, a phase difference between two image signals obtained from a plurality of pixels in a selected focus detecting area, and calculates a defocus amount of an object image from the phase difference. The camera control unit 10 calculates a focus control amount of the interchangeable lens 3 based on the defocus amount.

On the other hand, the interchangeable lens 3 includes an imaging optical system 32, which includes a focus lens, an image stabilizing lens, and an aperture stop, and a focus drive unit 33 configured to drive the focus lens included in the imaging optical system 32. The interchangeable lens 3 further includes a lens IS unit 34 and a lens control unit 30. The lens IS unit 34 is a lens drive unit configured to move the image stabilizing lens, which is an optical element serving as a movable element, in a direction orthogonal to the optical axis 31 (a direction different from the optical axis direction). The movement in the direction orthogonal to the optical axis 31 also includes a movement in a direction that has a component orthogonal to the optical axis 31 (rotation about a point on the optical axis 31).

The lens control unit 30 includes a CPU or the like and performs the overall control of the interchangeable lens 3. The lens control unit 30 can communicate with the camera control unit 10 via a lens contact 20, and performs control to drive the aperture stop or the focus lens in accordance with the aperture value (F-number) or the focus control amount received from the camera control unit 10, respectively. The lens control unit 30 also controls IS driving of the lens IS unit 34 or the LPF drive in accordance with a lens IS driving signal received from the camera control unit 10 in accordance with the lens IS amount or an LPF drive signal, respectively.

The lens control unit 30 includes a lens characteristic memory 30a configured to store information on drive characteristics of the lens IS unit 34 (referred to as lens drive characteristic information hereinafter). The lens drive characteristic information may be information that directly indicates the drive characteristics themselves of the lens IS unit 34, or information convertible into the drive characteristics.

A description will now be given of image stabilization using the shake detector 18, the sensor IS unit 17, and the lens IS unit 34 in more detail. The shake detector 18 includes an angular velocity sensor and an acceleration sensor, and detects angular velocity due to rotational shake of the camera 1 and acceleration due to translational shake of the camera 1. The IS control unit 10a calculates a rotational shake amount and a translational shake amount of the camera 1 by performing filter processing and integration processing on a shake signal which indicates the angular velocity and the acceleration detected by the shake detector 18. Based on the rotational shake amount and the translational shake amount, the IS control unit 10a calculates a sensor IS amount for the sensor IS unit 17 and a lens IS amount for the lens IS unit 34, and generates a sensor IS driving signal and a lens IS driving signal corresponding to the sensor IS amount and the lens IS amount, respectively.

In FIG. 1B, the optical axis direction in which the optical axis 31 extends is defined as a Z(-axis) direction, the object side in the Z direction is defined as a +Z direction, the vertical direction of the camera 1 is defined as a Y(-axis) direction, the upward direction is defined as a +Y direction, the horizontal direction of the camera 1 is defined as an X(-axis) direction, and the left side when viewed from the rear side is defined as a +X direction. The shake detector 18 can detect angular velocity due to rotational shake around three axes in the X, Y, and Z directions and acceleration due to translational shake in the three directions.

The sensor IS unit 17 reduces (corrects) image blur caused by camera shake in the pitch direction, the yaw direction, and the roll direction, by moving the image sensor 11 in the XY plane or rotating the image sensor 11 around the axis in the Z direction according to the above sensor IS driving signal.

The lens IS unit 34 corrects image blur caused by camera shake in the pitch direction and the yaw direction by moving the image stabilizing lens in the XY plane in response to the lens IS driving signal received from the camera control unit 10 (IS control unit 10a) via the lens control unit 30.

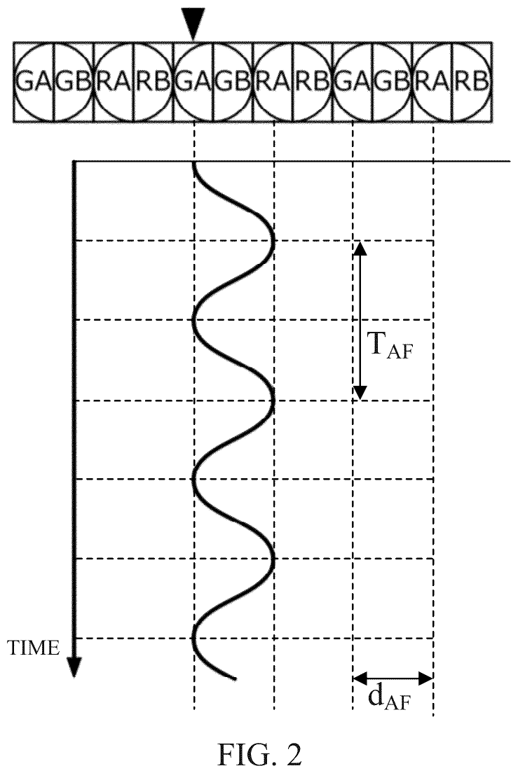

LPF drive will be described with reference to FIG. 2. In a camera without an optical low-pass filter (LPF), moire caused by aliasing distortion and false colors occur in a high spatial frequency region. As a result, focus detection accuracy and image quality of an image obtained by imaging are degraded. LPF drive is to periodically move (periodically drive) the sensor IS unit 17 or the lens IS unit 34 with a minute amplitude and at a high frequency, in order to obtain an LPF effect equivalent to the effect obtained by providing an LPF in front of the image sensor 11. Periodic movement includes movement that periodically passes through the same position, such as reciprocating movement, circular movement, or elliptical movement.

FIG. 2 illustrates the LPF drive of the sensor IS unit 17. An upper diagram of FIG. 2 illustrates a part of a pixel row in the image sensor 11 in which R (red) pixels and G (green) pixels are arranged in a Bayer pattern. As described above, each pixel of the image sensor 11 includes a microlens (indicated by a circle in the figure) and two subpixels A and B (indicated as GA, GB, RA, and RB in FIG. 2) serving as photoelectric converters divided in a horizontal direction. The microlens guides a light beam that has passed through an A region of an exit pupil of the imaging optical system 32 to the photoelectric converter A, and guides a light beam that has passed through a B region of the exit pupil to the photoelectric converter B. That is, pupil division is performed in the horizontal direction.

A lower diagram of FIG. 2 illustrates a temporal change in the position of the subpixel GA, marked with ▾ in the upper diagram, accompanying the movement of the image sensor 11 due to the LPF drive. A vertical axis represents elapsed time in a downward direction, and a horizontal axis represents the position of the subpixel GA. T_{AF} in the time direction represents a vertical synchronization period (an exposure time for focus detection or imaging). The focus detection is performed once within a time period that is an integer multiple of T_{AF}. d_{AF} in the position direction represents an interval between subpixels on the same side in two adjacent pixels (in the figure, the subpixel GA of the second pixel from the right and the subpixel RA of the right-adjacent pixel). A curve in the lower diagram illustrates a positional change in a case where the sensor IS unit 17 is periodically driven at a high frequency with an amplitude corresponding to the interval d_{AF}.

On the other hand, the LPF drive of the lens IS unit 34 periodically drives the image stabilizing lens at a high frequency in the pupil division direction (horizontal direction). A lower diagram of FIG. 2 in this case illustrates a temporal change in a position of a light beam focused at a position initially indicated by ▾ on the image sensor 11. That is, a vertical axis represents elapsed time, and a horizontal axis represents a position of the light beam on the image sensor 11. By periodically driving the lens IS unit 34 so that such a positional change of the light beam occurs, the light amount received by each pixel on the image sensor 11 becomes equivalent to that when the sensor IS unit 17 is periodically driven. Thus, the LPF effect can also be obtained by periodic driving of the lens IS unit 34. A drive amount of the image stabilizing lens in periodic driving of the lens IS unit 34 differs according to a moving amount of a light beam position on the image sensor 11 relative to a moving amount of the image stabilizing lens.

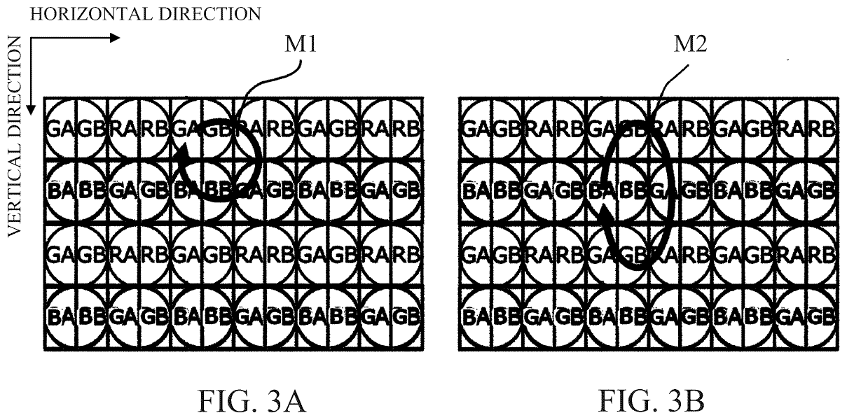

With reference to FIGS. 3A and 3B, a case will be described in which the driving directions of the sensor IS unit 17 and the lens IS unit 34 in the LPF drive are extended to directions other than a single direction. FIGS. 3A and 3B illustrate driving directions of the image sensor 11 in periodic driving of the sensor IS unit 17. Although FIG. 2 illustrates a case in which the image sensor 11 is periodically driven in the horizontal direction, which is the pupil division direction, since pixels are continuously provided in both the horizontal direction and the vertical direction in the image sensor 11, moire of an image may occur in both the horizontal direction and the vertical direction. Thus, as illustrated in FIG. 3A, the image sensor 11 or the image stabilizing lens may be periodically driven in a circular trajectory M1. False colors occur depending on a period of a color filter of the image sensor 11. Thus, as illustrated in FIG. 3B, the image sensor 11 or the image stabilizing lens may be periodically driven in an elliptical trajectory M2 having different amplitudes in the horizontal direction and the vertical direction.

A description will now be given of problems of the LPF drive and countermeasures thereof. In a case where a frame rate during imaging or focus detection is increased, the exposure time T_{AF} illustrated in FIG. 2 becomes extremely short. In order to obtain a sufficient LPF effect during this short exposure time T_{AF}, periodic driving may be performed as illustrated in FIGS. 3A and 3B for an integer number of cycles equal to one or more cycles during the exposure time T_{AF}. Thus, it is conceivable to change a drive frequency of the periodic driving in accordance with the exposure time T_{AF}. However, the sensor IS unit 17 and the lens IS unit 34 are originally configured on the premise of correcting image blur caused by camera shake in a low-frequency region (a first frequency region of about 1 Hz to 10 Hz), such as hand shake, and drive characteristics in a higher frequency region (a second frequency region) are not regarded as important. As a result, in the LPF drive in the high-frequency region, depending on the exposure time T_{AF}, the drive characteristics (frequency characteristics) of the sensor IS unit 17 or the lens IS unit 34 may not be favorable, and in an image stabilizing unit in which the drive characteristics are not favorable, LPF drive for obtaining a sufficient LPF effect may not be performed.

Accordingly, in this embodiment, drive characteristics of the sensor IS unit 17 and the lens IS unit 34 are compared for each exposure time, and the one having the most favorable drive characteristics for the LPF drive (suitable for the LPF drive) in the exposure time for focus detection or imaging is selected as the LPF image stabilizing unit. By selecting the LPF image stabilizing unit in consideration of the drive characteristics in this manner, a favorable LPF effect can be obtained even when the exposure time is short.

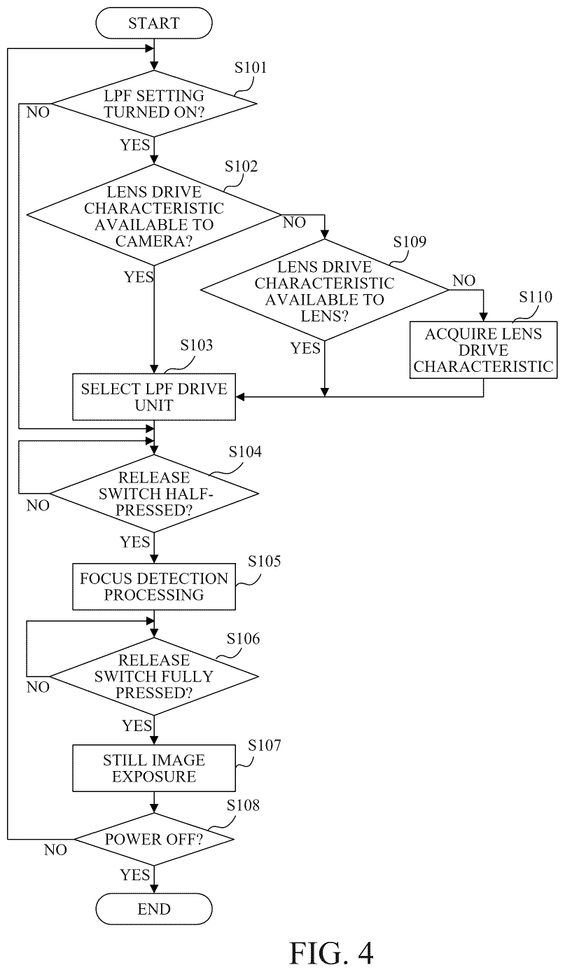

A flowchart in FIG. 4 illustrates imaging processing (control method) to be executed by the camera control unit 10 as a computer in accordance with a (computer) program. In the camera 1 according to this embodiment, a user can turn on or off LPF setting on a menu screen displayed on the display unit 16, and the camera control unit 10 performs the LPF drive in a case where the LPF setting is turned on, and does not perform the LPF drive in a case where the LPF setting is turned off.

In a case where the camera 1 is powered on, the camera control unit 10 starts this processing. In step S101, the camera control unit 10 determines whether the LPF setting is turned on. In a case where the LPF setting is turned on, the processing of step S102 is executed, and in a case where the LPF setting is turned off, the processing of step S104 is executed.

In step S102, the camera control unit 10 acquires identification information (hereinafter referred to as a lens ID) for identifying the interchangeable lens 3 from the interchangeable lens 3 attached to the camera 1, and determines whether lens drive characteristic information corresponding to the lens ID can be acquired from the characteristic memory 10c. In a case where the lens drive characteristic information can be acquired, the camera control unit 10 reads out the lens drive characteristic information from the characteristic memory 10c and sends it to the LPF drive selector 10b, and executes the processing of step S103. In a case where the lens drive characteristic information cannot be acquired, the camera control unit 10 executes the processing of step S109.

In step S103, the camera control unit 10 (LPF drive selector 10b) compares the drive characteristics of the sensor IS unit 17 indicated by the sensor drive characteristic information stored in the characteristic memory 10c with the drive characteristics of the lens IS unit 34 indicated by the lens drive characteristic information acquired in step S102. Then, in accordance with the comparison result, the camera control unit 10 (LPF drive selector 10b) selects the LPF image stabilizing unit, and the flow proceeds to step S104.

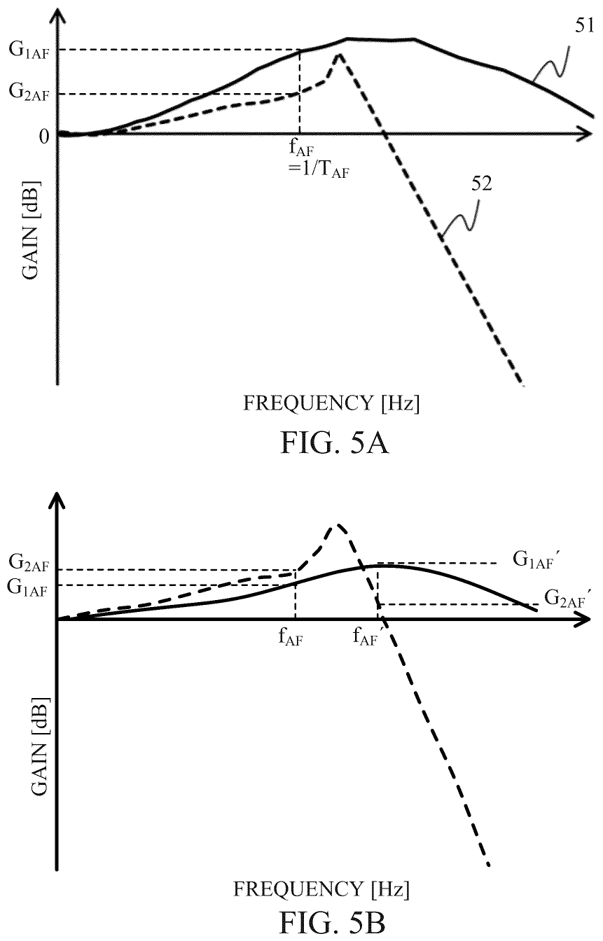

FIG. 5A illustrates respective drive characteristics (frequency characteristics) of the sensor IS unit 17 and the lens IS unit 34. A horizontal axis represents a drive frequency (Hz), and a vertical axis represents a gain (dB). A solid line 51 represents the frequency characteristic of the lens IS unit 34, and a broken line 52 represents the frequency characteristic of the sensor IS unit 17. f_{AF} represents the drive frequency at the exposure time T_{AF}, G_{1AF} represents the gain of the lens IS unit 34 at the drive frequency f_{AF}, and G_{2AF} represents the gain of the sensor IS unit 17 at the drive frequency f_{AF}. The drive frequency f_{AF} is, for example, 80 Hz.

The LPF drive selector 10b reads the frequency characteristics of the sensor IS unit 17 and the frequency characteristics of the lens IS unit 34. At this time, a frequency range in which the frequency characteristics are read can be set in the camera 1. More specifically, the range may include a frequency as a reciprocal of the exposure time for focus detection and still image capturing. This is because, as described above, periodic driving may be performed for an integer number of cycles equal to one or more cycles during the exposure time in the LPF drive. This description assumes that one cycle of periodic driving is performed during the exposure time. That is, the drive frequency f_{AF} is set to be a reciprocal of the exposure time T_{AF}.

When selecting the LPF image stabilizing unit at the exposure time T_{AF}, the LPF drive selector 10b compares an absolute value of the gain G_{1AF} of the lens IS unit 34 at the drive frequency f_{AF} with an absolute value of the gain G_{2AF} of the sensor IS unit 17 at the drive frequency f_{AF}, and selects the one having the smaller absolute value as the LPF image stabilizing unit. This is because, as the absolute value of the gain becomes greater than zero, the amplitude in periodic driving is amplified or attenuated relative to a value instructed by the camera control unit 10. Since amplification or attenuation of the amplitude relative to the instructed value results in failure to obtain a sufficient LPF effect, the image stabilizing unit in which the absolute value of the gain is closest to zero (that is, the drive characteristics are most suitable for the LPF drive) may be selected as the LPF image stabilizing unit. In FIG. 5A, since |G_{1AF}|>|G_{2AF}|, the sensor IS unit 17 is selected as the LPF image stabilizing unit.

FIG. 5B illustrates respective frequency characteristics of the sensor IS unit 17 and the lens IS unit 34 of another interchangeable lens 3 which is different from the interchangeable lens 3 including the lens IS unit 34 having the frequency characteristic illustrated in FIG. 5A. In this figure, since |G_{2AF}|>|G_{1AF}| at the drive frequency f_{AF} illustrated in FIG. 5A, the lens IS unit 34 is selected as the LPF image stabilizing unit. In contrast, at a drive frequency f_{AF}′ higher than the drive frequency f_{AF} (for example, 130 Hz), since |G_{1AF}′|>|G_{2AF}′|, the sensor IS unit 17 is selected as the LPF image stabilizing unit.

In this manner, the LPF drive selector 10b selects the LPF image stabilizing unit in accordance with a result of comparison between the frequency characteristics of the sensor IS unit 17 of the camera 1 and the lens IS unit 34 of a variety of interchangeable lenses 3 attachable to the camera 1.

The LPF drive selector 10b performs the above comparison for all exposure times settable in the camera 1, and selects the LPF image stabilizing unit for each exposure time. By such comparison and selection, even when the exposure time T_{AF} is extremely short, the favorable LPF drive can be performed to obtain a sufficient LPF effect. Information on the LPF image stabilizing unit selected for each exposure time is stored in the characteristic memory 10c and is referred to during the LPF drive.

It is not always necessary to select the LPF image stabilizing unit for each exposure time. For example, in a case where the absolute values of gains of the sensor IS unit 17 and the lens IS unit 34 fall within an allowable range for obtaining an LPF effect, the image stabilizing unit having a smaller absolute value of the gain at the shortest exposure time settable in the camera 1 may be selected as the LPF image stabilizing unit for all exposure times.

In step S104, the camera control unit 10 determines whether the release switch of the operation unit 15 has been half-pressed by a user. In a case where the half-press operation is performed, the camera control unit 10 executes the processing of step S105, and in a case where the half-press operation is not performed, the camera control unit 10 repeats the determination of step S104.

In step S105, the camera control unit 10 causes the focus detector 19 to perform focus detection processing, and causes the lens control unit 30 to drive the focus lens. The camera control unit 10 periodically drives the LPF IS unit selected in step S103 at the drive frequency corresponding to the exposure time for focus detection, stored in the characteristic memory 10c. Thereby, favorable focus detection accuracy can be obtained for an object including a high spatial frequency component, even without an LPF being provided.

Next, in step S106, the camera control unit 10 determines whether still image capturing has been instructed by a full-press operation of the release switch. In a case where the full-press operation is performed, the camera control unit 10 executes the processing of step S107, and in a case where the full-press operation is not performed, the camera control unit 10 repeats the determination of this step.

In step S107, the camera control unit 10 drives the shutter 14 to expose the image sensor 11 for still image capturing. The camera control unit 10 periodically drives the LPF image stabilizing unit selected in step S103 at a drive frequency corresponding to the exposure time for still image capturing, stored in the characteristic memory 10c. Thereby, even without an LPF being provided, a high-quality still image in which image quality degradation due to moire and false colors is suppressed can be obtained for an object including a high spatial frequency component.

Next, in step S108, the camera control unit 10 determines whether the power switch included in the operation unit 15 has been turned off. In a case where the power switch is turned off, the camera control unit 10 ends this processing, and in a case where the power switch is not turned off, the camera control unit 10 executes the processing of step S101.

On the other hand, in step S109, the camera control unit 10 checks whether lens drive characteristic information can be acquired from the lens characteristic memory 30a in the lens control unit 30. In a case where the lens drive characteristic information can be acquired, the camera control unit 10 acquires the information, sends it to the LPF drive selector 10b, and executes the processing of step S103. In a case where the lens drive characteristic information cannot be acquired, the camera control unit 10 executes the processing of step S110.

In step S110, the camera control unit 10 applies a sweep signal to the lens IS unit 34 via the lens control unit 30, and acquires the lens drive characteristic information from a response of the lens IS unit 34 (movement of the image stabilizing lens) to the sweep signal. A frequency range in which the sweep signal is applied may be set to include a frequency corresponding to a reciprocal of an exposure time for focus detection and still image capturing set in the camera 1. The camera control unit 10 which has thus acquired the lens drive characteristic information sends the lens drive characteristic information to the LPF drive selector 10b and proceeds to step S103.

At this time, the camera control unit 10 stores the acquired lens drive characteristic information in the characteristic memory 10c in association with a lens ID. The lens control unit 30 may also store the lens drive characteristic information in the lens characteristic memory 30a.

The method of acquiring the lens drive characteristic information described here is merely illustrative, and the camera control unit 10 may acquire the lens drive characteristic information by another acquisition method.

Thus, in this embodiment, during focus detection or during still image capturing, the LPF drive is performed by the LPF image stabilizing unit selected from the sensor IS unit 17 and the lens IS unit 34, the drive characteristics of which with respect to the exposure time are more favorable. Thereby, even when the exposure time for focus detection or during still image capturing is short, a sufficient LPF effect can be obtained.

The LPF drive can be superimposed on image stabilization drive for image stabilization of the sensor IS unit 17 or the lens IS unit 34. This is because a frequency region of the image stabilization drive frequency does not overlap with a frequency region of the LPF drive frequency. Thus, in a case where the sensor IS unit 17 and the lens IS unit 34 are driven for image stabilization at a predetermined image stabilizing ratio, it is not necessary to change an IS drive amount of the image stabilizing unit on which only image stabilization drive is performed and an IS drive amount of the image stabilizing unit on which both the IS drive and the LPF drive are performed, as compared with a case where the LPF drive is not performed.

In this embodiment, the camera 1 is a lens interchangeable type camera, but the camera may also be a lens integrated camera in which the lens is integrated with the camera.

In this embodiment, a single image stabilizing unit is provided in the camera 1 and one image stabilizing unit is provided in the interchangeable lens 3, but two image stabilizing units may be provided in at least one of the camera 1 and the interchangeable lens 3. In this case, drive characteristics of each of up to four image stabilizing units (two or more drive units) may be compared, and the LPF image stabilizing unit may be selected.

### Second Embodiment

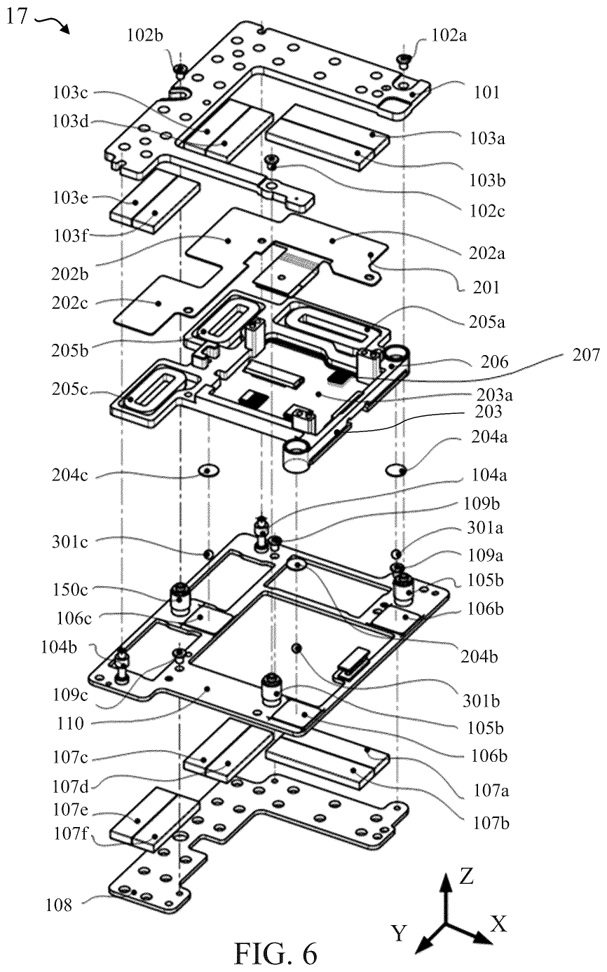

FIG. 6 illustrates the configuration of a sensor IS unit 17 according to a second embodiment. Vertical lines in FIG. 6 indicate lines extending in an optical axis direction. In FIG. 6, members constituting a fixed portion which does not move with respect to a housing of the camera 1 are denoted by reference numerals in the 100s, members constituting a movable unit which moves with respect to the fixed portion are denoted by reference numerals in the 200s, and balls disposed between the fixed portion and the movable unit are denoted by reference numerals in the 300s.

A reference numeral 101 denotes an upper yoke, reference numerals 102a, 102b, and 102c denote screws, reference numerals 103a, 103b, 103c, 103d, 103e, and 103f denote upper magnets, reference numerals 104a and 104b denote auxiliary spacers, and reference numerals 105a, 105b, and 105c denote main spacers. Reference numerals 106a, 106b, and 106c denote fixed rolling plates, reference numerals 107a, 107b, 107c, 107d, 107e, and 107f denote lower magnets, a reference numeral 108 denotes a lower yoke, reference numerals 109a, 109b, and 109c denote screws, and a reference numeral 110 denotes a base plate.

A reference numeral 201 denotes a flexible printed circuit (board) (FPC), reference numerals 202a, 202b, and 202c denote sensor attachment positions, a reference numeral 203 denotes a movable frame, a reference numeral 203a denotes a movable printed circuit board (movable PCB), and reference numerals 204a, 204b, and 204c denote movable rolling plates. Reference numerals 205a, 205b, and 205c denote coils, a reference numeral 206 denotes a movable frame, reference numerals 301a, 301b, and 301c denote balls, and a reference numeral 207 denotes a piezoelectric element unit.

A closed magnetic path as a magnetic circuit is formed by the upper yoke 101, the upper magnets 103a, 103b, 103c, 103d, 103e, and 103f, the lower magnets 107a, 107b, 107c, 107d, 107e, and 107f, and the lower yoke 108. The upper magnets 103a, 103b, 103c, 103d, 103e, and 103f are adhesively fixed in a state of being attracted to the upper yoke 101. The lower magnets 107a, 107b, 107c, 107d, 107e, and 107f are adhesively fixed in a state of being attracted to the lower yoke 108.

The upper magnets 103a, 103b, 103c, 103d, 103e, and 103f and the lower magnets 107a, 107b, 107c, 107d, 107e, and 107f are magnetized in the optical axis direction, respectively, and two adjacent magnets (for example, magnets 103a and 103b) are magnetized in opposite directions to each other. In addition, two magnets facing each other (for example, magnets 103a and 107a) are magnetized in the same direction. This magnetization can generate a strong magnetic flux density in the optical axis direction between the upper yoke 101 and the lower yoke 108, and a strong attractive force between the upper yoke 101 and the lower yoke 108.

Thus, a proper distance is maintained between the main spacers 105a, 105b, and 105c and the auxiliary spacers 104a and 104b. The term “proper distance” herein refers to a distance which allows the coils 205a, 205b, and 205c and the FPC 201 to be disposed between the upper magnets 103a, 103b, 103c, 103d, 103e, and 103f and the lower magnets 107a, 107b, 107c, 107d, 107e, and 107f while securing a sufficient gap.

Screw holes are provided in the main spacers 105a, 105b, and 105c, and the upper yoke 101 is fixed to the main spacers 105a, 105b, and 105c by the screws 102a, 102b, and 102c inserted into the screw holes.

A rubber is provided on the bodies of the main spacers 105a, 105b, and 105c, forming mechanical ends (so-called stoppers) of the movable unit.

Holes are formed in the base plate 110 so as to avoid the lower magnets 107a, 107b, 107c, 107d, 107e, and 107f, and surfaces of the magnets protrude from the holes. That is, the base plate 110 and the lower yoke 108 are fixed by the screws 109a, 109b, and 109c, and the lower magnets 107a, 107b, 107c, 107d, 107e, and 107f, which have a dimension in the thickness direction larger than that of the base plate 110, protrude from the base plate 110.

The movable frame 203 is formed of magnesium die-cast or aluminum die-cast, and is lightweight and has high rigidity. Each component of the movable unit is fixed to the movable frame 203, thereby constituting the movable unit. Position sensors are mounted at the sensor attachment positions 202a, 202b, and 202c on the surface of the FPC 201 on the side of the piezoelectric element unit 207. As the position sensors, Hall elements capable of detecting positions of the movable unit by utilizing the above-described magnetic circuit are used. The Hall elements, which are small in size, are disposed inside the coils 205a, 205b, and 205c. Sensors other than the Hall elements may also be used as the position sensors.

The movable PCB 203a fixed to the movable frame 203 is connected to the image sensor 11 as the movable element illustrated in FIG. 1B (not illustrated in FIG. 6), the coils 205a, 205b, and 205c, and the Hall elements, and these components perform electrical communication with the outside through a connector on the movable PCB 203a.

The fixed rolling plates 106a, 106b, and 106c are adhesively fixed to the base plate 110, and the movable rolling plates 204a, 204b, and 204c are adhesively fixed to the movable frame 203. Each rolling plate forms a rolling surface of the balls 301a, 301b, and 301c. By providing each rolling plate separately from the base plate 110 and the movable frame 203, surface roughness, hardness, and the like of each rolling plate can be desirably set.

By supplying currents to the respective coils in the above-described configuration, an electromagnetic force is generated in accordance with Fleming's left-hand rule, whereby the movable unit can be driven relative to the fixed portion in a plane perpendicular to the optical axis. The position of the movable unit can be feedback-controlled using signals from the above-described Hall elements. Specifically, the movable unit can be translated in the plane perpendicular to the optical axis or rotated around an axis parallel to the optical axis. By driving the movable unit such that the signal from the Hall element at the sensor attachment position 202b and the signal from the Hall element at the sensor attachment position 202c become opposite in phase while keeping the signal from the Hall element at the sensor attachment position 202a constant, the movable unit can be approximately rotated around the optical axis.

The sensor IS unit 17 according to this embodiment can periodically drive the movable unit in a low-frequency region and with a first amplitude by supplying currents to the coils, and further includes the piezoelectric element unit 207 capable of driving the movable unit in a high-frequency region higher than the low-frequency region and with a second amplitude smaller than the first amplitude. By applying a voltage to a piezoelectric element provided in the piezoelectric element unit 207, a displacement is generated in the piezoelectric element, whereby the movable unit can be driven in the high-frequency region with the minute second amplitude.

Hereinafter, a mechanism for driving the movable unit in the low-frequency region (low speed) with a first stroke by energizing the coils will be referred to as a low-speed drive mechanism (second low-speed drive unit), and a mechanism for driving the movable unit in the high-frequency region (high speed) with a second stroke smaller than the first stroke by energizing the piezoelectric element will be referred to as a high-speed drive mechanism (second high-speed drive unit). The high-speed drive mechanism may use a driving element other than the piezoelectric element.

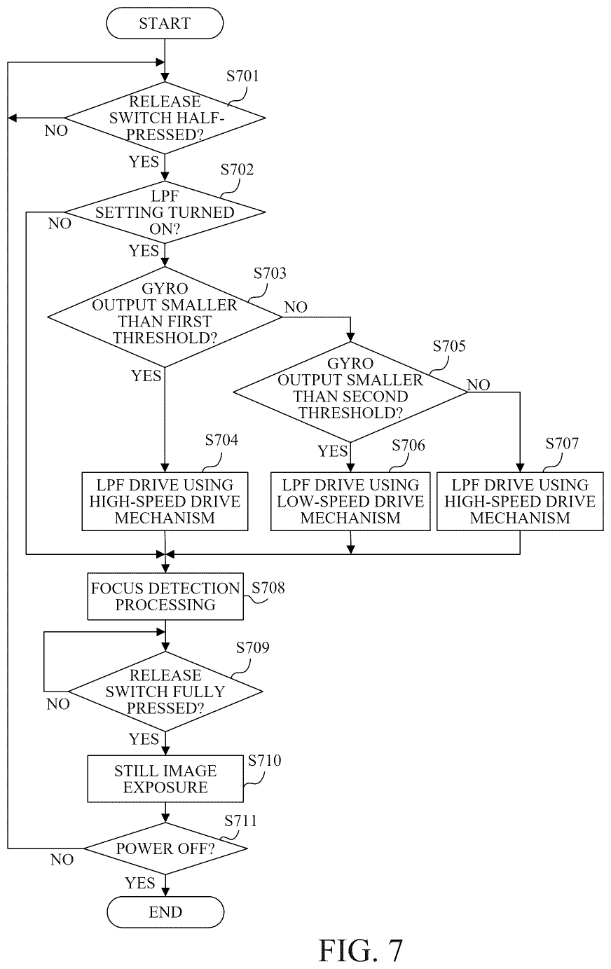

A flowchart in FIG. 7 illustrates imaging processing (control method) according to this embodiment. Here, a description will be given of processing in a case where the camera 1 illustrated in FIGS. 1A and 1B includes the sensor IS unit 17 illustrated in FIG. 6. In this embodiment, unlike in the first embodiment, the drive characteristics of the sensor IS unit 17 and the lens IS unit 34 are not compared. Instead, a drive mechanism to be used for the LPF drive is selected from among the low-speed drive mechanism and the high-speed drive mechanism in accordance with the magnitude of camera shake (gyro output) detected by the shake detector 18, and a drive mechanism to be used for image stabilization is also selected.

When the camera 1 is powered on, the camera control unit 10 starts this processing. In step S701, the camera control unit 10 determines whether the release switch of the operation unit 15 has been half-pressed by the user. In a case where the half-press operation is performed, the camera control unit 10 executes the processing of step S702. In a case where the half-press operation is not performed, the camera control unit 10 repeats the determination of step S701.

In step S702, the camera control unit 10 determines whether the LPF setting is turned on. In a case where the LPF setting is turned on, the camera control unit 10 executes the processing of step S703. In a case where the LPF setting is turned off, the camera control unit 10 executes the processing of step S708.

In step S703, the camera control unit 10 determines whether a gyro output from the shake detector 18 is smaller than a first threshold value (first predetermined value). The first threshold value is a value close to zero, and this determination corresponds to determining whether the camera 1 is supported by a support member such as a tripod. In a case where the gyro output is smaller than the first threshold value, the camera control unit 10 executes the processing of step S704, and in a case where the gyro output is equal to or greater than the first threshold value, the camera control unit 10 executes the processing of step S705.

In step S704, the camera control unit 10 (LPF drive selector 10b) selects the high-speed drive mechanism for the LPF drive and performs the LPF drive using this drive mechanism. At this time, the camera control unit 10 performs the LPF drive of the high-speed drive mechanism at a drive frequency corresponding to an exposure time for focus detection, which is stored in the characteristic memory 10c illustrated in FIGS. 1A and 1B. Since camera shake such as hand shake hardly occurs when the camera 1 is supported by the support member such as a tripod, a favorable LPF effect can be obtained by performing the LPF drive using the high-speed drive mechanism. The low-speed drive mechanism is not used for image stabilization either. Then, the camera control unit 10 executes the processing of step S708.

In step S705, the camera control unit 10 determines whether the gyro output from the shake detector 18 is smaller than a second threshold value (second predetermined value). The second threshold value is a value larger than the first threshold value, and this determination corresponds to determining whether camera shake has occurred due to hand shake or the like. In a case where the gyro output is smaller than the second threshold value, the camera control unit 10 executes the processing of step S706, and in a case where the gyro output is equal to or greater than the second threshold value, the camera control unit 10 executes the processing of step S707.

In step S706, the camera control unit 10 selects the low-speed drive mechanism for the LPF drive and the high-speed drive mechanism for the image stabilization, and drives these drive mechanisms. Here, the drive frequency of the LPF drive is a drive frequency corresponding to an exposure time for focus detection, stored in the characteristic memory 10c or in the lens characteristic memory 30a illustrated in FIGS. 1A and 1B. Thus, while the high-speed drive mechanism corrects image blur caused by relatively high-frequency camera shake, the low-speed drive mechanism can provide a favorable LPF effect. Then, the camera control unit 10 executes the processing of step S708.

In step S707, the camera control unit 10 selects the high-speed drive mechanism for the LPF drive and the low-speed drive mechanism for the image stabilization, and drives these drive mechanisms. At this time, the camera control unit 10 performs the LPF drive of the high-speed drive mechanism at a drive frequency corresponding to an exposure time for focus detection, stored in the characteristic memory 10c. In a case where camera shake is large, the influence of high-frequency camera shake is small. Thus, while the low-speed drive mechanism performs image stabilization, the high-speed drive mechanism can provide a favorable LPF effect. Then, the camera control unit 10 executes the processing of step S708.

Next, in step S708, the camera control unit 10 causes the focus detector 19 to perform focus detection processing and causes the lens control unit 30 to drive the focus lens.

Next, in step S709, the camera control unit 10 determines whether still image capturing has been instructed by a full-press operation of the release switch. In a case where the full-press operation is performed, the camera control unit 10 executes the processing of step S710, and in a case where the full-press operation is not performed, the camera control unit 10 repeats the determination of step S709.

In step S710, the camera control unit 10 drives the shutter 14 to expose the image sensor 11 for still image capturing. At this time, in a case where the high-speed drive mechanism has been selected for the LPF drive in step S704 or step S707, the camera control unit 10 performs the LPF drive at the drive frequency corresponding to an exposure time for still image capturing, stored in the characteristic memory 10c. In a case where the low-speed drive mechanism has been selected for the LPF drive in step S706, the camera control unit 10 performs the LPF drive at the drive frequency corresponding to an exposure time for still image capturing, stored in the characteristic memory 10c or the lens characteristic memory 30a.

Next, in step S711, the camera control unit 10 determines whether the power switch included in the operation unit 15 has been turned off. In a case where the power switch is turned OFF, the camera control unit 10 ends this processing, and in a case where the power switch is not turned off, the camera control unit 10 executes the processing of step S701.

In a case where the sensor IS unit 17 has both the low-speed drive mechanism and the high-speed drive mechanism, this embodiment can provide a favorable image stabilization effect and a favorable LPF effects. Image stabilization may be simultaneously performed by using the high-speed drive mechanism or the low-speed drive mechanism for the LPF drive.

In this embodiment, a drive mechanism for the LPF drive is selected from the low-speed drive mechanism and the high-speed drive mechanism of the sensor IS unit 17 in accordance with the gyro output. However, the lens IS unit 34 may be selected as the LPF drive unit. The lens IS unit 34 may also be provided with two drive mechanisms, and in this case, drive characteristics of up to four drive mechanisms may be compared to select the LPF drive unit.

For example, in step S706, the camera control unit 10 selects and drives either the low-speed drive mechanism of the sensor IS unit 17, or the low-speed or high-speed drive mechanism of the lens IS unit 34, for the LPF drive. Here, the camera control unit 10 reads the frequency characteristics of the sensor IS unit 17 and the lens IS unit 34. When selecting the LPF drive unit at the exposure time T_{AF}, the camera control unit 10 compares the absolute value of the gain G_{1AF} of the lens IS unit 34 at the drive frequency f_{AF} with the absolute value of the gain G_{2AF} of the sensor IS unit 17 at the drive frequency f_{AF}, and selects as the LPF drive unit the one having the smaller absolute value. Here, the drive frequency for the LPF drive may be a drive frequency corresponding to the exposure time for focus detection, which is stored in the characteristic memory 10c or the lens characteristic memory 30a illustrated in FIGS. 1A and 1B. Thereby, while the high-speed drive mechanism corrects image blur caused by relatively high-frequency camera shake, the low-speed drive mechanism can provide a favorable LPF effect. In this embodiment, the camera 1 is a lens interchangeable type camera, but the camera 1 may also be a lens integrated camera in which the lens is integrated with the camera.

### Third Embodiment

In the second embodiment, the camera control unit 10 selects the LPF drive unit based on the camera shake detected by the shake detector 18. However, in a case where an output of any one of the components among the roll component, the pitch component, and the yaw component detected by the angular speed sensor is significantly larger, the LPF drive may not be able to provide a sufficient LPF effect. Accordingly, the outputs of the roll component, the pitch component, and the yaw component may be compared, and the LPF drive unit may be selected according to the comparison result. Here, the roll component is a rotational component around the Z-axis in FIG. 1B, the pitch component is a rotational component around the X-axis in FIG. 1B, and the yaw component is a rotational component around the Y-axis in FIG. 1B.

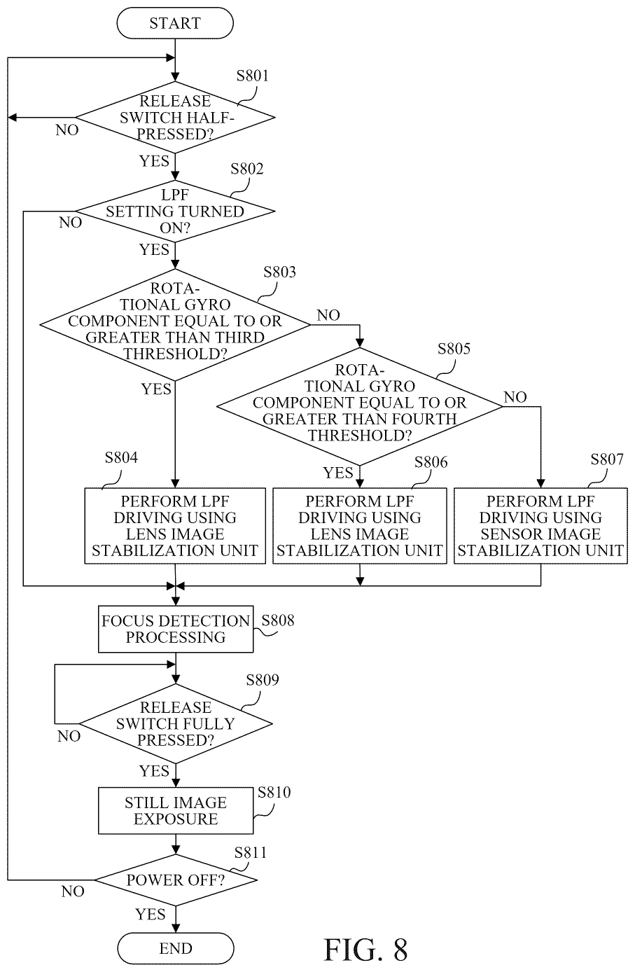

A flowchart in FIG. 8 illustrates imaging processing (control method) according to a third embodiment. The configuration of the image pickup apparatus according to this embodiment is equivalent to that according to the first embodiment, and thus a description thereof will be omitted.

When the power of the camera 1 is turned on, the camera control unit 10 starts this processing. In step S801, the camera control unit 10 determines whether the release switch of the operation unit 15 has been half-pressed by the user. In a case where the half-press operation is performed, the camera control unit 10 executes the processing of step S802, and in a case where the half-press operation is not performed, the camera control unit 10 repeats the determination of step S801.

In step S802, the camera control unit 10 determines whether the LPF setting is turned on. In a case where the LPF setting is turned on, the camera control unit 10 executes the processing of step S803, and in a case where the LPF setting is turned off, the camera control unit 10 executes the processing of step S808.

In step S803, the camera control unit 10 determines whether the output of the roll component from the angular speed sensor in the shake detector 18 is equal to or greater than a third threshold value (third predetermined value). This determination corresponds to determining whether significant camera shake in the roll direction has occurred due to hand shake or the like. In a case where the output of the roll component is equal to or greater than the third threshold value, the camera control unit 10 executes the processing of step S804, and in a case where the rotational component is less than the third threshold value, the camera control unit 10 executes the processing of step S805.

In step S804, the camera control unit 10 (LPF drive selector 10b) selects the lens IS unit 34 for the LPF drive and performs the LPF drive thereof. At this time, the camera control unit 10 performs the LPF drive for the lens IS unit 34 at the drive frequency corresponding to the exposure time for focus detection, stored in the characteristic memory 10c. Thereafter, the camera control unit 10 executes the processing of step S808.

In step S805, the camera control unit 10 determines whether a ratio of the roll component to the pitch and yaw components from the angular speed sensor in the shake detector 18 is equal to or greater than a fourth threshold value (fourth predetermined value). This determination corresponds to determining whether shake in the roll direction is superior to shakes in the pitch and yaw directions among the camera shakes detected by the angular speed sensor. In a case where the ratio of the roll component to the pitch and yaw components is equal to or greater than the fourth threshold value, the camera control unit 10 executes the processing of step S806, and in a case where the ratio is less than the fourth threshold value, the camera control unit 10 executes the processing of step S807.

The ratio for the determination is not particularly limited, and may use a ratio of the roll component to the square root of the sum of the squares of the pitch and yaw components, or a ratio of the roll component to each of the pitch and yaw components. In a case where the ratio of the roll component to each of the pitch and yaw components is used for the determination, the processing in step S806 may be performed when the ratio to both the pitch and yaw components is equal to or greater than the fourth threshold, or when the ratio to either component is equal to or greater than the fourth threshold.

In step S806, since the roll component of the output from the angular speed sensor is dominant, the camera control unit 10 selects the lens IS unit 34 for the LPF drive and performs the LPF drive thereof. At this time, the camera control unit 10 performs the LPF drive of the lens IS unit 34 at the drive frequency corresponding to the exposure time for focus detection, stored in the characteristic memory 10c. Thereafter, the camera control unit 10 executes the processing of step S808.

In step S807, the camera control unit 10 selects the sensor IS unit 17 for the LPF drive and performs the LPF drive thereof. At this time, the camera control unit 10 performs the LPF drive of the sensor IS unit 17 at the drive frequency corresponding to the exposure time for focus detection, stored in the characteristic memory 10c or the lens characteristic memory 30a. Thereafter, the camera control unit 10 executes the processing of step S808.

The camera control unit 10 may read the frequency characteristic of the sensor IS unit 17 and the frequency characteristic of the lens IS unit 34, and select the LPF drive unit by comparing the frequency characteristics. When selecting the LPF drive unit at the exposure time T_{AF}, the camera control unit 10 compares the absolute value of the gain G_{1AF} of the lens IS unit 34 at the drive frequency f_{AF} with the absolute value of the gain G_{2AF} of the sensor IS unit 17 at the drive frequency f_{AF}, and selects the one having the smaller absolute value as the LPF drive unit.

Next, in step S808, the camera control unit 10 causes the focus detector 19 to perform focus detection processing, and causes the lens control unit 30 to drive the focus lens.

Next, in step S809, the camera control unit 10 determines whether still image capturing has been instructed by a full-press operation of the release switch. In a case where the full-press operation is performed, the camera control unit 10 executes the processing of step S810, and in a case where the full-press operation is not performed, the camera control unit 10 repeats the determination of step 809.

In step S810, the camera control unit 10 drives the shutter 14 to expose the image sensor 11 for still image capturing. At this time, in a case where the lens IS unit 34 has been selected for the LPF drive in step S804 or step S806, the camera control unit 10 performs the LPF drive at the drive frequency corresponding to the exposure time for still image capturing, stored in the characteristic memory 10c or lens characteristic memory 30a. In a case where the sensor IS unit 17 has been selected for the LPF drive in step S807, the camera control unit 10 performs the LPF drive at the drive frequency corresponding to the exposure time for still image capturing, stored in the characteristic memory 10c.

Next, in step S811, the camera control unit 10 determines whether the power switch included in the operation unit 15 has been turned off. In a case where the power switch is turned off, the camera control unit 10 ends this processing, and in a case where the power switch is not turned off, the camera control unit 10 executes the processing of step S801.

This embodiment can provide a favorable LPF effect in accordance with the component of the gyro output from the shake detector 18.

The LPF drive can be superimposed on the image stabilization drive for image stabilization performed by the sensor IS unit 17 or the lens IS unit 34. This is because the frequency range of the image stabilization driving does not overlap that of the LPF drive. Thus, in a case where the sensor IS unit 17 and the lens IS unit 34 are driven for image stabilization at a certain image stabilizing ratio, it is not necessary to change the amount of image stabilization driving of the image stabilizing unit on which only the image stabilization driving is performed and the amount of image stabilization driving of the image stabilizing unit on which both the image stabilization driving and the LPF drive are performed, as compared with the case where the LPF drive is not performed.

In this embodiment, the camera 1 is a lens interchangeable type camera, but the camera 1 may also be a lens integrated camera in which the lens is integrated with the camera.

In this embodiment, one image stabilizing unit is provided in the camera 1 and one image stabilizing unit is provided in the interchangeable lens 3. However, two image stabilizing units may be provided in at least one of the camera 1 and the interchangeable lens 3. In this case, drive characteristics of each of up to four image stabilizing units (two or more drive units) may be compared, and the LPF image stabilizing unit may be selected.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide the LPF drive of a movable element which can provide a favorable LPF effect.

This application claims the benefit of Japanese Patent Application No. 2024-215125, filed on Dec. 10, 2024, and No. 2025-186322, filed on Nov. 5, 2025 which are hereby incorporated by reference herein in their entirety.

What is claimed is:

1. A control apparatus comprising:
one or more memories storing instructions; and
one or more processors that, upon execution of the instructions, operate to:
control a plurality of drive units, each of which moves a movable element, which is either an optical element included in an imaging optical system or an image sensor configured to receive a light beam from the imaging optical system, in a direction different from an optical axis direction of the imaging optical system, and
select, by using information on a drive characteristic of each of the plurality of drive units, a periodic drive unit for periodically moving the movable element among the plurality of drive units.

2. The control apparatus according to claim 1, wherein the one or more processors operate to select the periodic drive unit using an exposure time of the image sensor and the information on the drive characteristic.

3. The control apparatus according to claim 1, wherein the one or more processors operate to select, as the periodic drive unit, a drive unit that has the smallest absolute value of gain in the drive characteristic among the plurality of drive units.

4. The control apparatus according to claim 1, wherein the one or more processors operate to select the periodic drive unit using the information on the drive characteristic stored in the one or more memories or the information on the drive characteristic acquired from outside the one or more memories.

5. The control apparatus according to claim 4, wherein the one or more processors operate to:
acquire the information on the drive characteristic of one of the plurality of drive units configured to drive the image sensor from the one or more memories provided in an image pickup apparatus that includes the image sensor, and
acquire the information on the drive characteristic of another of the plurality of drive units configured to drive the optical element from a lens apparatus that includes the imaging optical system and is attachable to and detachable from the image pickup apparatus.

6. The control apparatus according to claim 1, wherein the one or more processors operate to:
perform a control to cause at least one of the plurality of drive units to move the movable element at a first frequency range for image stabilization, by using information on shake, and
control the periodic drive unit at a second frequency range higher than the first frequency range.

7. A control apparatus comprising:
one or more memories storing instructions; and
one or more processors that, upon execution of the instructions, operate to:
control driving of a first drive unit configured to move an optical element included in an imaging optical system in a direction different from an optical axis direction of the imaging optical system, and driving of a second drive unit configured to move an image sensor configured to receive a light beam from the imaging optical system, in a direction different from the optical axis direction, and
select, by using information on shake, from among the first drive unit and the second drive unit, a periodic drive unit configured to move the optical element or the image sensor with a period different from a period of image stabilization during an exposure time.

8. The control apparatus according to claim 7, wherein the first drive unit includes a first low-speed drive unit configured to move the optical element in a first frequency range, and a first high-speed drive unit configured to move the optical element in a second frequency range higher than the first frequency range, and
wherein the one or more processors operate to select one of the first low-speed drive unit, the first high-speed drive unit, and the second drive unit as the periodic drive unit.

9. The control apparatus according to claim 7, wherein the second drive unit includes a second low-speed drive unit configured to move the image sensor in a first frequency range, and a second high-speed drive unit configured to move the image sensor in a second frequency range higher than the first frequency range, and
wherein the one or more processors operate to select one of the first drive unit, the second low-speed drive unit, and the second high-speed drive unit as the periodic drive unit.

10. The control apparatus according to claim 9, wherein the information on the shake includes a shake amount of an image pickup apparatus, and
wherein the one or more processors operate to select, as the periodic drive unit,
the second high-speed drive unit in a case where the shake amount is smaller than a first predetermined value,
the second low-speed drive unit in a case where the shake amount is greater than the first predetermined value and smaller than a second predetermined value, and
the second high-speed drive unit in a case where the shake amount is greater than the second predetermined value.

11. The control apparatus according to claim 7, wherein the one or more processors operate to select, by using the information on the shake, from among the first drive unit and the second drive unit, a drive unit configured to perform image stabilization and the periodic drive unit, respectively.

12. The control apparatus according to claim 7, wherein the one or more processors operate to select the periodic drive unit by further using information on frequency characteristic of each of the first drive unit and the second drive unit.

13. The control apparatus according to claim 7, wherein the one or more processors operate to select the periodic drive unit from among the first drive unit and the second drive unit by using a shake amount of an image pickup apparatus as the information on the shake.

14. The control apparatus according to claim 13, wherein the one or more processors operate to select the first drive unit as the periodic drive unit in a case where a roll component of the shake amount of the image pickup apparatus is greater than a third predetermined value.

15. The control apparatus according to claim 7, wherein the information on the shake includes a direction of the shake of an image pickup apparatus, and
wherein the one or more processors operate to selects, as the periodic drive unit, the first drive unit in a case where a ratio of a magnitude of a roll component to magnitudes of a pitch component and a yaw component is greater than the fourth predetermined value.

16. The control apparatus according to claim 7, wherein the information on the shake includes a direction of the shake of an image pickup apparatus, and
wherein the one or more processors operate to selects, as the periodic drive unit, the second drive unit in a case where a ratio of a magnitude of a roll component to magnitudes of a pitch component and a yaw component is less than the fourth predetermined value.

17. An optical apparatus comprising:
the control apparatus according to claim 1; and
at least one of the optical element and the image sensor.

18. An optical apparatus comprising:
the control apparatus according to claim 7; and
at least one of the optical element and the image sensor.

19. A control method comprising:
controlling a plurality of drive units, each of which moves a movable element, which is either an optical element included in an imaging optical system or an image sensor configured to receive a light beam from the imaging optical system, in a direction different from an optical axis direction of the imaging optical system, and
selecting, by using information on a drive characteristic of each of the plurality of drive units, a periodic drive unit for periodically moving the movable element among the plurality of drive units.

20. A control method comprising:
controlling driving of a first drive unit configured to move an optical element included in an imaging optical system in a direction different from an optical axis direction of the imaging optical system, and a second drive unit configured to move an image sensor configured to receive a light beam from the imaging optical system, in a direction different from the optical axis direction of the imaging optical system, and
selecting, by using information on shake, from among the first drive unit and the second drive unit, a periodic drive unit configured to move the optical element or the image sensor with a period different from a period of image stabilization during an exposure time.

21. A non-transitory computer-readable storage medium storing a program that causes a computer to execute the control method according to claim 19.

22. A non-transitory computer-readable storage medium storing a program that causes a computer to execute the control method according to claim 20.
